(19) United States
(12) Patent Application Publication
(10) Pub. No.: US 2015/0092227 A1
(43) Pub. Date: Apr. 2, 2015

(54) VIRTUAL CLOUD PRINTING

(71) Applicants: Alon ROSENBERG, Kfar Saba (IL); Eyal ROSENBERG, Kfar Saba (IL); Assaf STERN, Givat Ada (IL)

(72) Inventors: Alon ROSENBERG, Kfar Saba (IL); Eyal ROSENBERG, Kfar Saba (IL); Assaf STERN, Givat Ada (IL)

(73) Assignee: Nipendo Ltd., Netanya (IL)

(21) Appl. No.: 14/314,056

(22) Filed: Jun. 25, 2014

Related U.S. Application Data
(60) Provisional application No. 61/847,091, filed on Jul. 17, 2013.

(51) Int. Cl. G06Q 10/08; G06F 3/12; G06Q 10/10

(52) U.S. Cl. CPC G06Q 10/08; G06Q 10/10; G06F 3/1209; G06F 3/1276
USPC 358/1.15

(57) ABSTRACT

A supply chain management system comprising: a system server comprising a central processor and a database; a plurality of user computers communicating with the system server over a network; the system server running a software process defining: an interface layer configured to communicate messages and business transactions bi-directionally between the user computers and the system server; and a services layer configured to apply business logic to the messages and business transaction and process them according to a predefined workflow of the supply chain management system; the plurality of user computers running client applications configured to communicate with the interface layer, the client applications comprising a virtual printer driver and virtual cloud printer application configured to virtually print documents into the system using the virtual print driver; the service layer comprising a cloud printer service configured to communicate bi-directionally with the virtual cloud printer application and with the database.

### FIELD OF THE INVENTION

The present invention is in the field of computerized supply chain management systems and pertains more particularly to inputting documents to the system using a virtual cloud printer.

### BACKGROUND

Supply chain management is considered nowadays as one of the most prominent subjects in the Information Technology (IT) domain and is characterized by the fastest growth rate in the Enterprise IT domain and with many technological developments.

A supply chain management system is a software platform for electronic connectivity between businesses (B2B). The platform enables the creation of a cooperative electronic commerce community for clients, suppliers and business partners, for performing all the supply-chain related activities automatically and electronically.

### SUMMARY

According to a first aspect of the present invention there is provided a supply chain management system comprising: a system server comprising a central processor and a database; a plurality of user computers communicating with the system server over a network; said system server running a software process defining: an interface layer configured to communicate messages and business transactions bi-directionally between said user computers and said system server; and a services layer configured to apply business logic to said messages and business transaction and process them according to a predefined workflow of said supply chain management system; said plurality of user computers running client applications configured to communicate with said interface layer, said client applications comprising a virtual printer driver and virtual cloud printer application configured to virtually print documents into the system using said virtual print driver; said service layer comprising a virtual cloud printer service configured to communicate bi-directionally with said virtual cloud printer application and with said database.

The virtual printer driver may be configured to receive a document and create therefrom a print file and an image file.

The virtual cloud printer application may comprise a virtual schema builder module configured to interactively build a schema definition for a new document format.

The virtual cloud printer service may comprise a data extraction module configured to identify a document type and the virtual cloud printer application may comprise a manual document input module configured to transfer virtually printed documents to the data extraction module.

Identifying a document type may comprise searching for keywords associated with different document definition schemas.

The virtual cloud printer application may comprise a document point and extract module configured to interactively complete missing data in a virtually printed document.

According to a second aspect of the present invention there is provided a method of introducing a new schema of a document to a supply chain management system, comprising: receiving a print file and an image file for each of a plurality of documents of a given document type; locating anchor fields in the document according to said document type; displaying said image file and marking said located anchor fields on said display; receiving corrections to said displayed anchor fields; creating or updating a schema for the given document type; and storing said schema.

Receiving a print file and an image file of a document may comprise virtually printing said document.

The method may further comprise testing said created schema by receiving a print file and an image file for each of a number of test documents and analyzing said print file with said stored schema.

According to a third aspect of the present invention there is provided a method of manually inputting a document to a supply chain management system, comprising: receiving a print file and an image file of said document; extracting data from said print file; identifying said document type, schema and content based on said extracted data; if said document is identified as a transaction, converting said document into an internal system format and storing said converted document; and if said document is not identified as a transaction, receiving a related transaction ID and connecting the document with said related transaction.

Identifying document schema may comprise: rating schemas in a system repository according to best match of predefined key anchors; and defining the document schema as the schema having the highest score.

Rating a schema may comprise: for each anchor field defined in the schema, finding anchor field in the document and comparing anchor field location in the document to location defined in schema.

The method may further comprise defining offsets for anchor fields in the document.

Identifying document content may comprise: for each singular data field defined in the schema, rate data field according to location relative to related anchors.

### BRIEF DESCRIPTION OF THE DRAWINGS

For better understanding of the invention and to show how the same may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1 is a schematic functional representation of a supply chain management system;

FIG. 2 is a schematic functional representation of the interface layer according to some embodiments;

FIG. 3 is a schematic functional representation of the services layer according to some embodiments;

FIG. 4 is schematic representation of the functional modules invoked by the process manager and their inter-relations;

FIG. 5 is a schematic representation of the virtual cloud printer service connectivity according to embodiments of the present invention;

FIG. 6 is a flowchart showing the main steps of integrating virtually printed new document formats according to embodiments of the present invention;

FIG. 7 is a flowchart showing the details of the print file analysis process according to embodiments of the present invention;

FIG. 8 is a flowchart showing the details of the virtual cloud printer manual input process according to embodiments of the present invention;

FIG. 9 is a flowchart showing the details of the data extraction process according to embodiments of the present invention;

FIG. 10 is a flowchart showing the details of the document type identification process according to embodiments of the present invention;

FIG. 11 is a flowchart showing the details of the anchors locating and rating process according to embodiments of the present invention;

FIG. 12 is a flowchart showing the details of the field offsets calculation process according to embodiments of the present invention;

FIG. 13 is a flowchart showing the details of the singular fields relative positioning rating process according to embodiments of the present invention; and

FIG. 14 shows an exemplary invoice document displayed with highlighted best matching anchors.

### DETAILED DESCRIPTION OF PREFERRED EMBODIMENTS

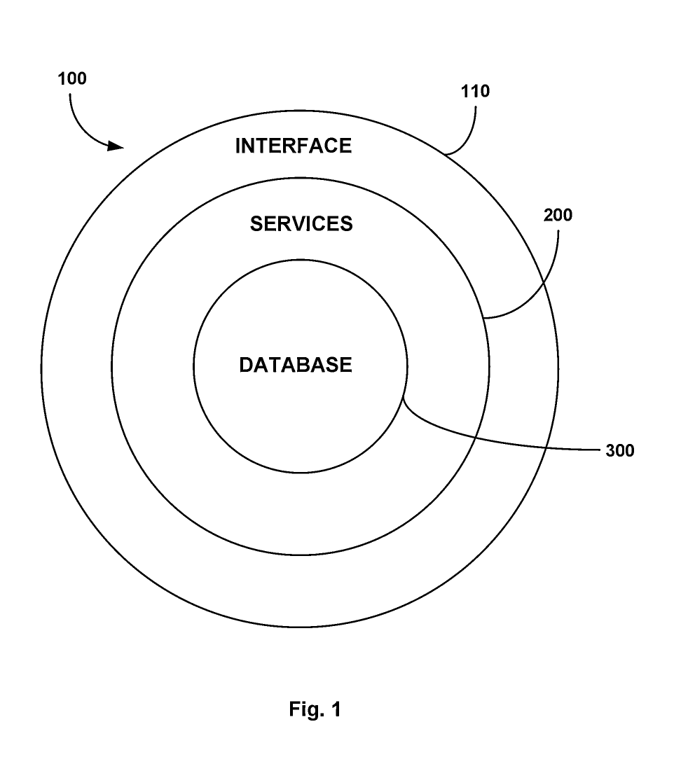

FIG. 1 is a schematic functional representation of a supply chain management system 100. The system 100 is transaction-motivated, where a transaction may be any business related document (e.g. purchase order, invoice, etc.) provided to the system by one of its users (e.g. client) and intended for another system user (e.g. supplier).

The system 100 comprises three main functional layers which interact with each other to provide the required capabilities: interface layer 110, services layer 200 and database 300.

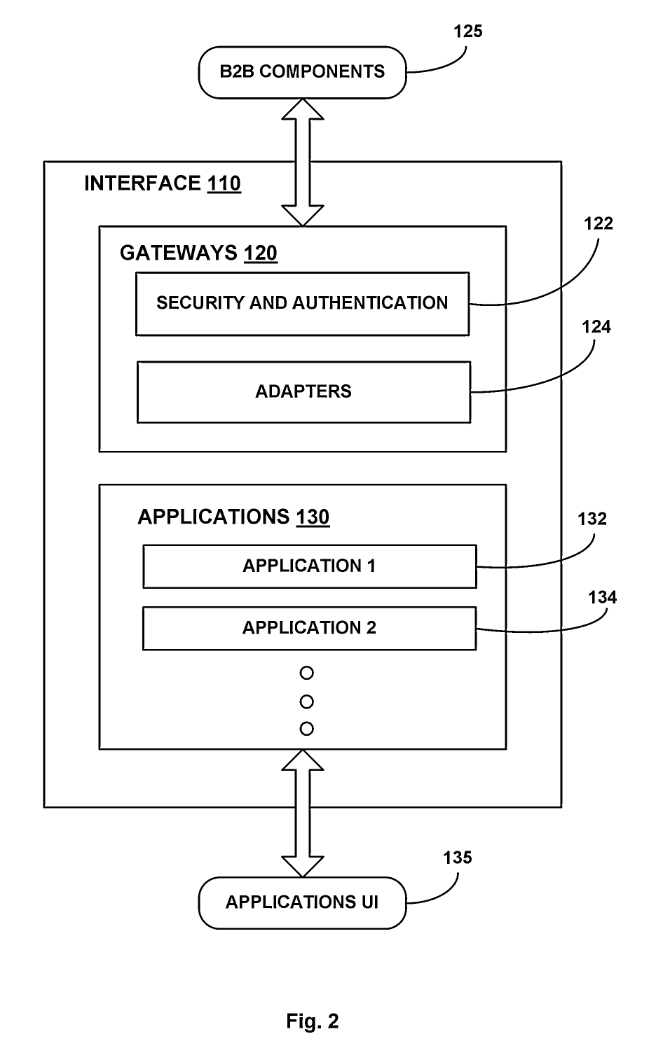

FIG. 2 is a schematic functional representation of the interface layer 110, which connects the system 100 with its users for inputting messages and transactions into the system and receiving messages and transactions from the system. Several modes of communication may be supported. For example, the system may communicate directly with B2B components 125 comprising, for example, modules of the user's ERP system. Transactions received from B2B components may be directed by the system to various gateways 120, such as, for example, RosettaNet, CXML and EDI, for security and authentication checks 122 and for conversion of the transaction in the B2B component format into a common system data format (e.g. XML) by a suitable adapter 124.

An additional or alternative mode of communication between the system and the users may be provided, namely direct interaction mode, where the user is provided with user interfaces (UI) 135 to various applications 130, enabling her to enter transaction data into the system and receive data from the system. The applications may be provided as web services or as client applications communicating with a server application. The applications may allow operations such as, for example, database searches, reports creation, transactions creation (e.g. create an invoice from an order), etc.

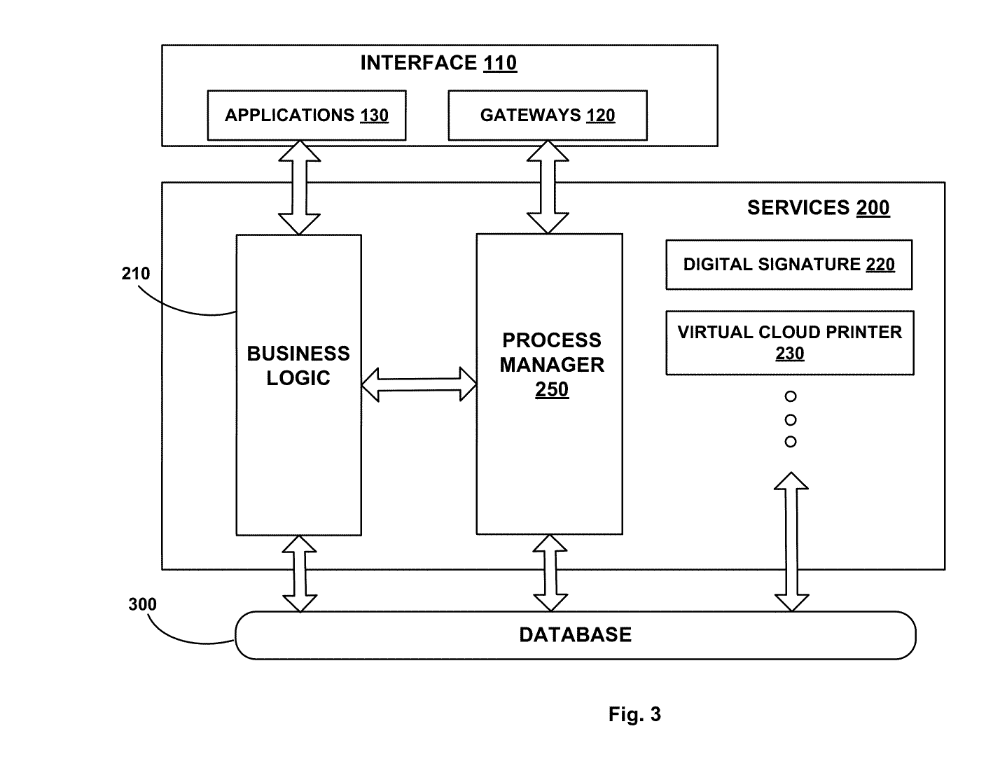

FIG. 3 is a schematic functional representation of the services layer 200, which mediates between the interface layer 110 and the database 300 to enable the various system operations. At the core of service layer 200 are the process manager 250 and the business logic module 210.

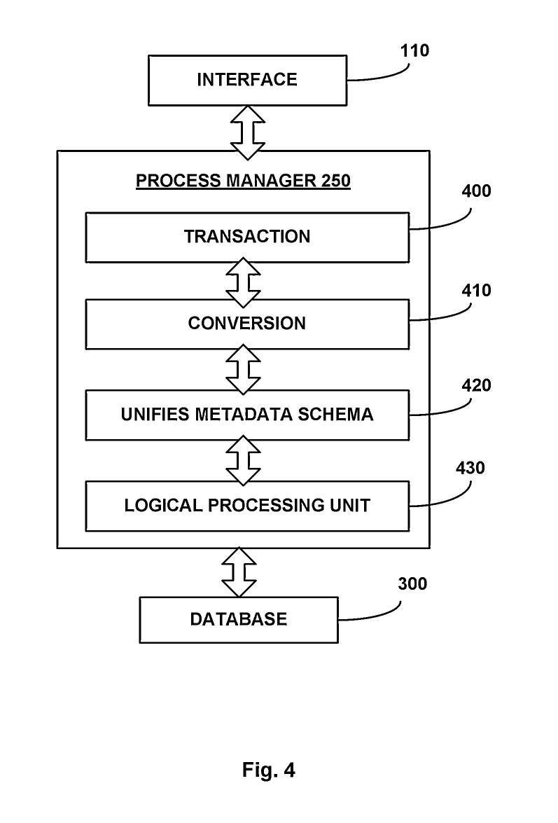

Process manager 250 is in charge of receiving B2B transactions and messages from the gateways 120 and managing the business process by invoking the appropriate services 200 in the right order, as will be explained in detail in conjunction with FIG. 4.

Business logic module 210 separates business logic from other system modules. It receives requests from the applications 130 and handles them according to request type. For example, business logic module 210 may create a transaction such as a new invoice as a result of user activity in an application and pass it on to the process manager 250 for further handling. In another example, the business logic module 210 may receive a request for a report via an application, e.g. “show all the open orders of a user”, which it may handle internally in compliance with a predefined set of permissions, etc.

Database 300 stores transactions and messages. Transactions may be stored in any suitable format for further processing such as XML or a proprietary format. Database 300 may additionally store transaction (e.g. invoices) images in a format such as PDF.

FIG. 4 is schematic representation of the functional modules invoked by the process manager 250 and their inter-relations. Transaction module 400 receives a transaction from the interface layer 110, saves it in the database and transfers it to the conversion module 410 for conversion from e.g. native XML to a proprietary internal format (UMS 420). The conversion process includes translation of the data structure and contents, completing missing data or correcting data according to pre-stored business logic data (e.g. in the order line the Total Line Quantity may be missing and the conversion process can calculate this information and derive it from the Quantity and Unit Price fields) and storing in database 300. The processed transaction is passed on to the logical processing unit (LPU) which identifies the relevant business event, e.g. new order, invoice status or warehouse receipt, etc., the transaction source and destination and its place in the business process as defined for the sender and receiver in the business logic module 210.

The LPU may put a transaction on hold, e.g. in wait for additional event, or initiate a process in response, e.g. sending a received purchase order to the supplier. The initiated process gets the transaction from the database 300 and transfers it to the interface layer 110 for delivery to its destination in the appropriate format.

According to embodiments of the present invention, the supply chain management system 100 comprises a virtual cloud printer service 230, which enables easy integration of new document formats into the system 100.

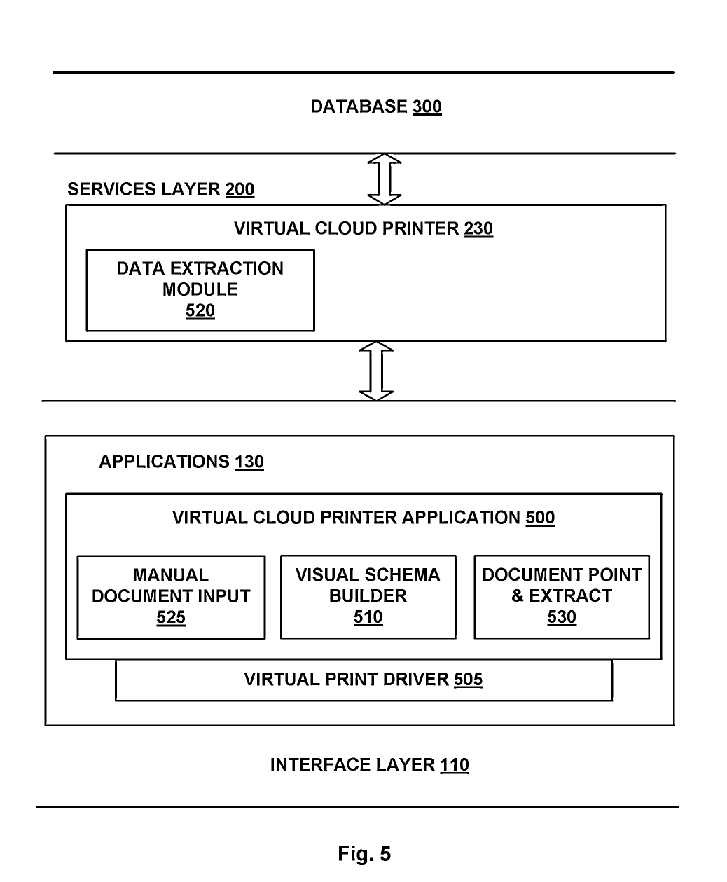

FIG. 5 is a schematic representation of the virtual cloud printer service 230 connectivity according to embodiments of the present invention. Virtual cloud printer service 230 is connected with the interface layer 110, for receiving documents “printed” to the virtual printer application 500 installed on a user's local machine and with the database 300 for storing and retrieving documents.

The virtual printer application 500 comprises:
Virtual print driver 505: receives virtual print command for a document and creates two files—a standard image file (e.g. PDF) and a print definition file;
Visual schema builder 510: interactive building of a schema definition for a new document format;
Manual document input module 525: transferring virtually printed documents to the data extraction module 520 for identification;
Document point & extract module 530: interactive completion of missing data in a virtually printed document.

The virtual cloud printer service 230 comprises a data extraction module 520 that identifies a document type by searching for keywords associated with different document definition schemas.

According to embodiments of the present invention, the virtual cloud printer may serve as means for introducing new document formats to the supply chain management system 100, enabling quick and simple integration.

Virtual Schema Builder 510

The application guides the user through a visual mapping process of a print sample which represents a format of a selected document type. The user is prompted to upload 10-20 different prints of the same document type (e.g. invoices) using the Cloud Printer. The system tries to identify the constant captions which are repeated in all the prints. The user is then asked to identify both constant and variable data by going over a list of required fields and pointing their location on the image. This list of fields includes:
Constant text captions to be used as anchors;
Data fields holding variable information.

The outcome of this process is a visual definition schema for locating and extracting the data out of the original print definition file based on the following characteristics:
General location in the document;
Relative location to anchors;
Font type and size;
Expected data type (numeric, alpha numeric, date, amounts, etc.).

To complete the setup the user is asked to upload an additional number of similar documents. These documents are processed based on the visual definition schema and the results are displayed for the user's approval.

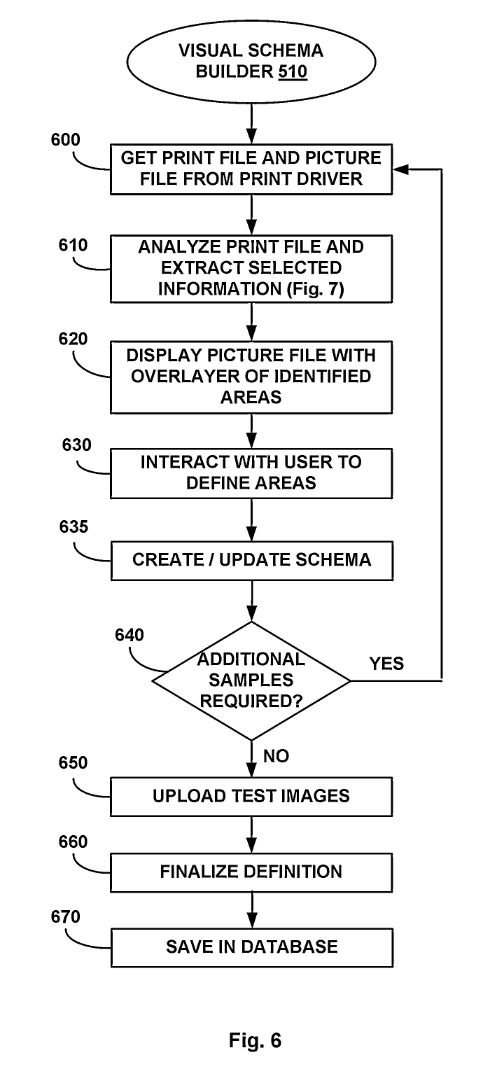

FIG. 6 is a flowchart showing the main steps of integrating virtually printed new document formats.

The virtual schema builder uses sample documents of the required type, virtually printed by the user, to extract therefrom the data required for building the schema definition. The sample documents preferably cover a variety matching the document specified nature.

In step 600 the virtual schema builder 510 receives, for each virtually printed sample document, two files from the virtual cloud printer driver 505:
A print file (e.g. in XML format) including text and graphics elements and document layout, i.e. position of each element on the document (e.g. coordinates relative to document's top-left corner).
An image file of the document (e.g. in PDF format).

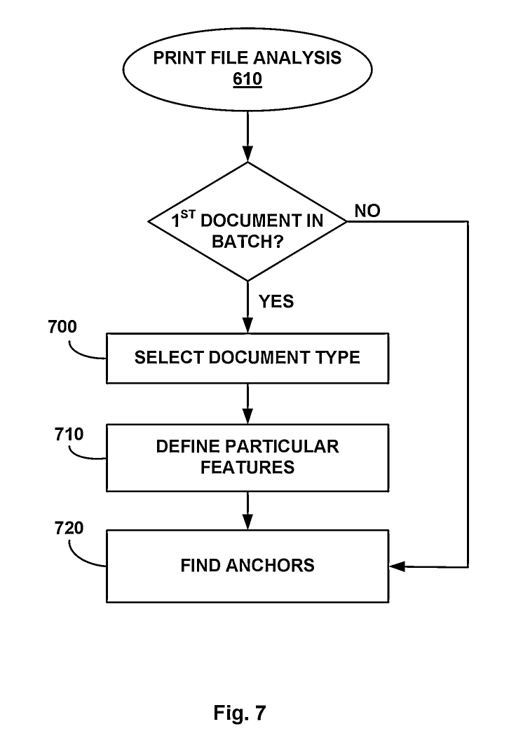

In step 610 the print file is analyzed to extract selected information, as will be described in detail in conjunction with FIG. 7. Business documents usually have a fixed structure, which includes the data layout (e.g. header, footer, lines) and fixed text captions located in predefined positions (e.g. document number). The analysis extracts selected information based on its position, relative location to other elements and other parameters.

In step 620 the image file is displayed in the application window with a transparent over layer outlining the various distinct areas identified in the print file.

In step 630 the user is prompted to define each of the outlined areas including constant text captions or graphic elements (e.g. “invoice number”, “date”, logo) which will later be used by the application as anchors and data fields holding variable information (e.g. actual invoice number, actual date, item name, quantity, etc.).

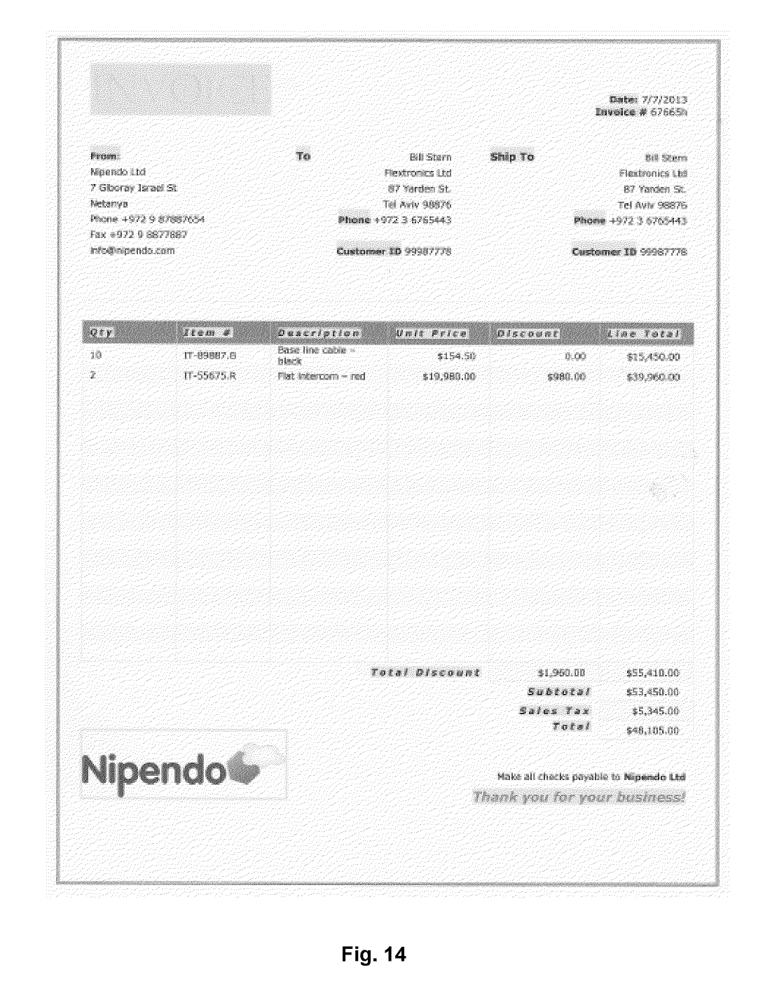

In step 635 the visual schema builder 510 creates (or updates) the schema for the document's layout and the user may be presented with best matching anchors as identified based on the previous steps, such as shown, for example, in FIG. 14. The user may be asked to mark missing anchors and add additional ones if such exist.

In step 640 the application determines whether additional samples are required for enhancing the schema. The decision may be based on a predefined number of samples per schema building or may use quality criteria such as, for example, convergence of the number and quality of updates to the schema.

If it is determined that more samples are required, an additional similar document is sent to the virtual cloud printer and the process loops back to step 600.

Alternatively, a predefined number of samples may be initially “printed” followed by being sequentially analyzed as described in conjunction with steps 610 through 635.

If the application determines that the schema is well defined, or if the predefined number of samples have been “printed” and analyzed, the user is prompted to virtually “print” an additional number (e.g. two) of test documents of the same type (step 650) as a test run, whereby the application uses the newly built schema to analyze the document image.

In step 660 the new schema definition is finalized and saved (step 670) in the system database 300 for further reference.

FIG. 7 is a flowchart showing the details of the print file analysis process 610.

If the virtually printed document is the first of its kind, the user is prompted in step 700 to select a document type (e.g. order, invoice etc.) from a predefined list of documents.

In step 710 the user is presented with a number of question relating to the document nature (e.g. always single page? Header duplicates for each page? etc.).

In step 720 the schema definition algorithm locates and defines anchors in the document according to expected fields for the document type (e.g. invoice number, issue date, etc. for a document of type invoice). The quality of the anchors location is expected to improve with each additional document of the same batch being virtually printed by using patterns of text repetition in nearby positions using the previously uploaded documents.

According to embodiments of the present invention the virtual cloud printer may provide a new method of manually inputting documents of types known to the system into the supply chain management system 100 by registered users.

The workflow involving the virtual cloud printer manual input may be divided into two main processes:

a. Virtual printing and transferring the resulting print and image files to the data extraction module 520;
b. Processing virtually printed documents to extract all the data fields therein.

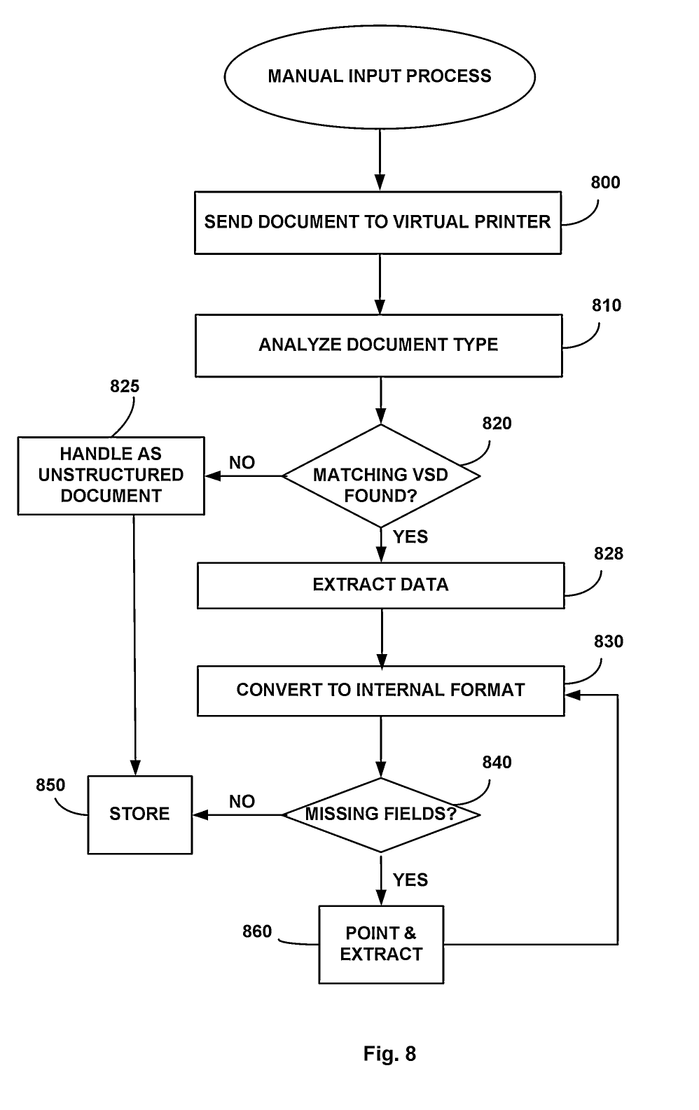

FIG. 8 is a flowchart showing the details of the virtual cloud printer manual input process.

In step 800 the user sends a document to the virtual printer, resulting in the virtual printer creating two files: a print file and an image file.

In step 810 the process analyzes the document type. If the document is not recognized as a transaction, i.e. no matching Virtual Schema Definition (VSD) is found, the user may be prompted in step 825 to identify the transaction to which the document should be attached (e.g. an Excel sheet detailing invoiced work hours).

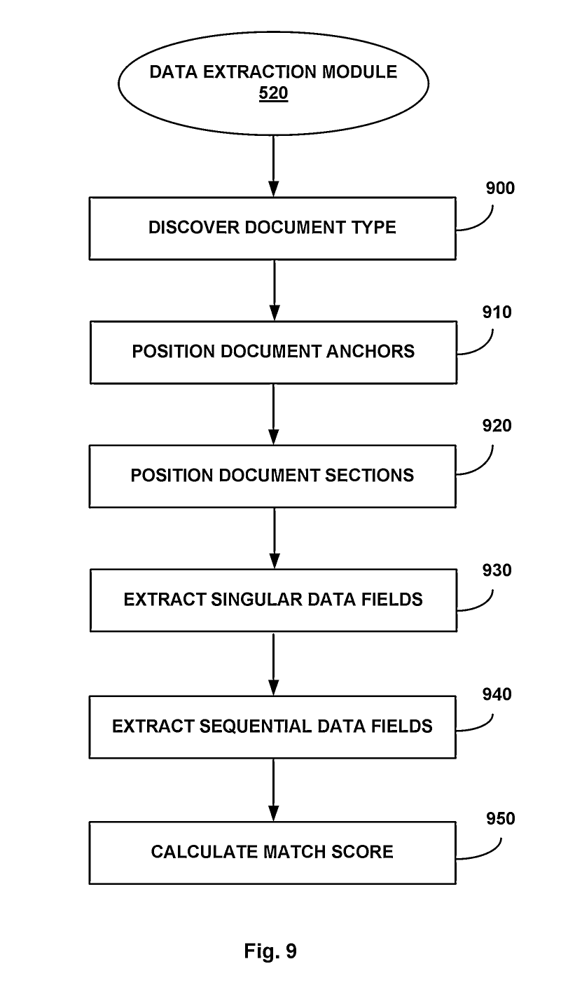

Otherwise, data extraction process 520 is invoked in step 828, as described in details in conjunction with FIGS. 9 through 13.

Following the data extraction process 520, the conversion module 410 may attempt 830 to fill in missing data. For example, if the document is an invoice that includes an order number, missing data such as number of ordered items may be filled from the order. Automatically filled data is then displayed to the user for confirmation.

For missing data that cannot be automatically filled (840), document point & extract module 530 may be invoked (860). Module 530 displays the document and the user is prompted to manually intervene and point out the location where the missing data is displayed. The data is then extracted and incorporated in the schema for future reference.

In step 850, the converted document is stored in the system's database 300.

FIG. 9 is a flowchart showing the details of the data extraction process 520.

In step 900 the system identifies the document type by searching for key words associated with the different visual definition schemas that exist in the system.

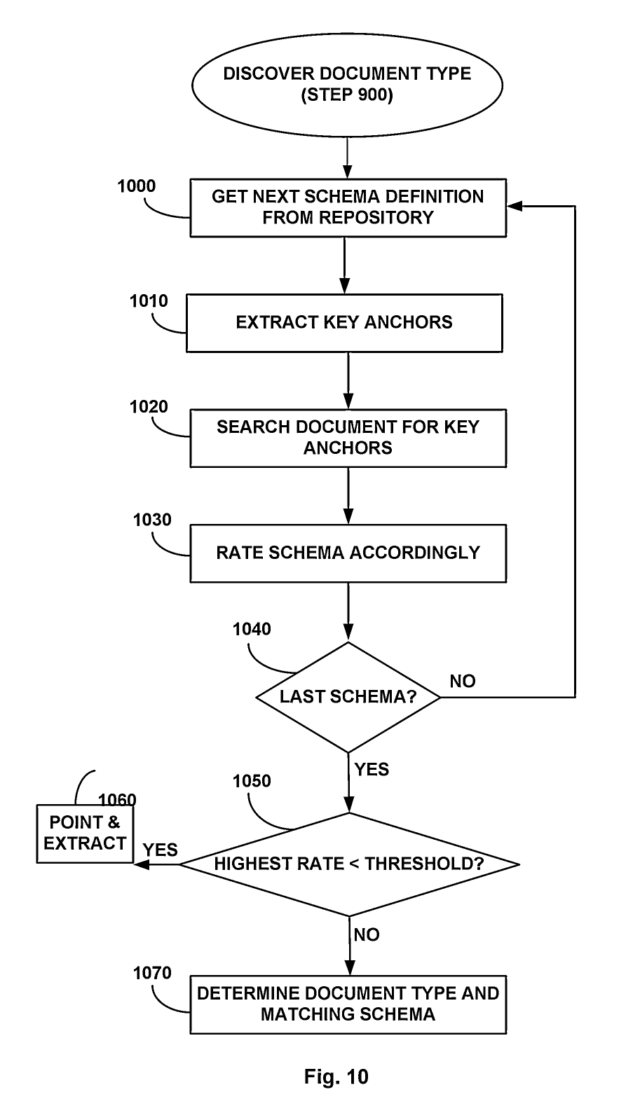

The document type identification algorithm is described in the flowchart of FIG. 10.

For each visual definition schemas (step 1000) the algorithm:
Extracts key anchors from schema (1010);
Searches for the key anchors in the document (1020);
Rates matching of document to the schema based on the number of key anchors found (1030);
selects highest rating schema (1050);
If highest rating is lower than Z % (predefined threshold) then processing is stopped and the document point and extract module 530 is invoked, as will be explained in detail below (1060).
Otherwise, document type and matching visual definition schema are determined (1050).

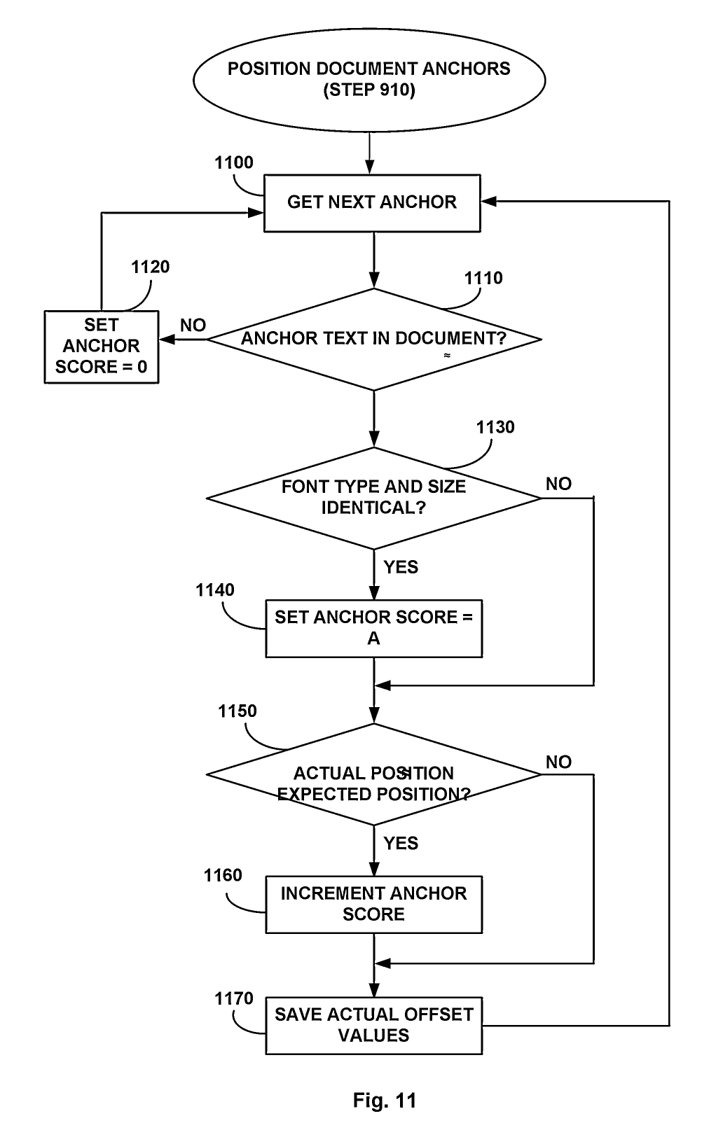

In step 910, following the determination of the document type, the data extraction process 520 searches and locates all anchors listed in the determined definition schema and rates them based on existence, matching font size & type and expected location, as described in the flowchart of FIG. 11.

For each anchor in the determined schema (step 1100), the algorithm:
Search for anchor text (e.g. “Invoice No.”) in document (1110);
If text does not exist in document—sets score=0 for the anchor (1120) and proceeds to check the next anchor;
If anchor text exists in document—compares font type and size (1130);
If identical—sets score=A for the anchor (1140);
Compares actual position of text to expected position (1150);
If identical or within predefined boundaries—increment score for anchor (1160);
Save offset values (1170).

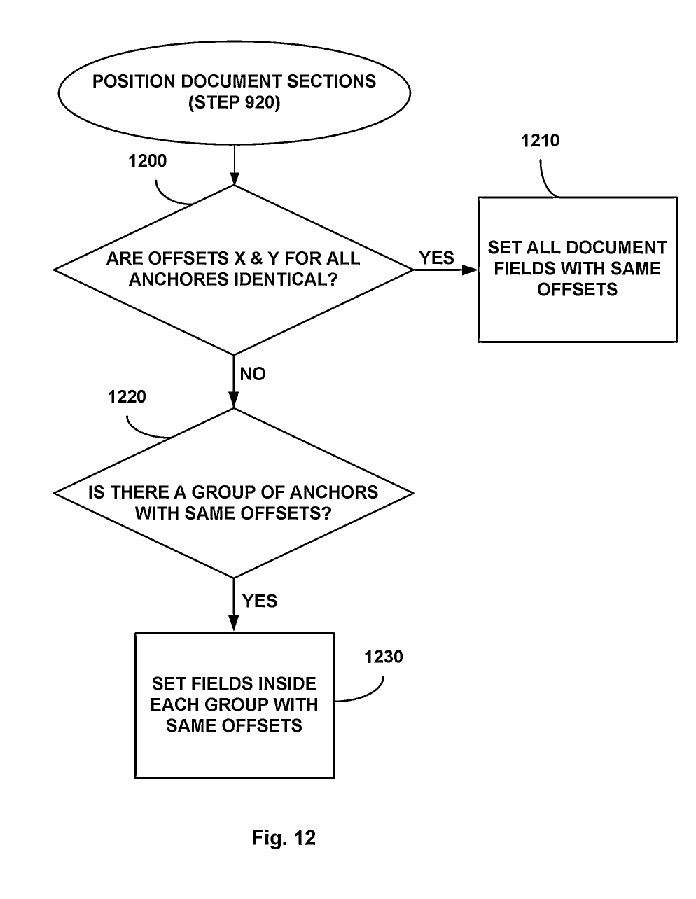

In step 920 the data extraction process 520 compares the anchors' actual positions as found in the document and decides whether a global offset should be defined for all other fields, as described in the flowchart of FIG. 12.
The algorithm checks whether all anchors' offsets for X & Y axis are the same (with tolerance of X %) (1200);
If affirmative—all fields of the document are positioned with the same offset (1210);
Otherwise, the algorithm searches for groups of fields having similar offsets (1220);
If groups are found—for each group the fields inside the group are positioned with the same offset (1230).

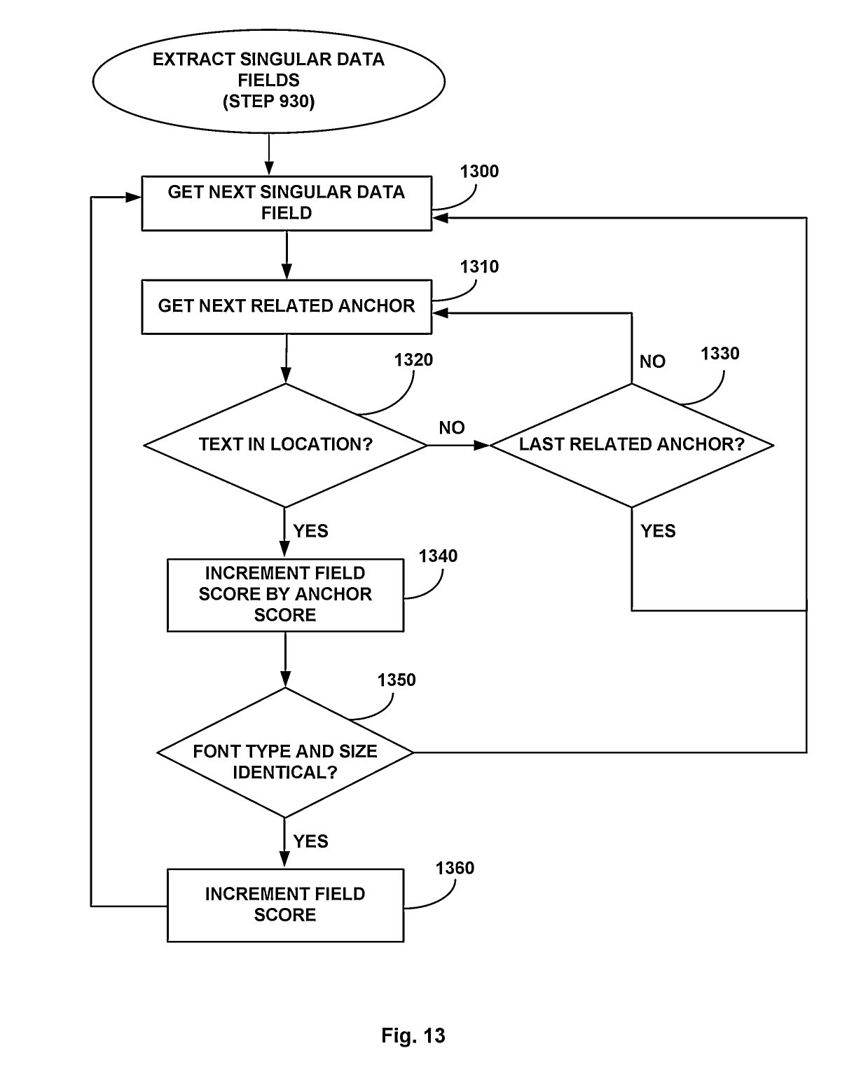

In step 930 the data extraction process 520 goes over the expected singular (variable) data fields list (e.g. actual invoice number) and extracts each value based on its relative position to the anchors associated with it, as described in the flowchart of FIG. 13:
For each singular data field defined in the schema (1300) and for each anchor related to the singular data field (1310);
The algorithm searches for text in location defined in the schema (1320);
If found—field score+=anchor score (1340);
If the font type and size in the field are identical to those defined in the schema—increment field score (1360).

In step 940 the data extraction process 520 goes over the expected sequential data groups (e.g. invoice item lines), identifies each group positioning boundaries and then extracts each instance of the sequence based on its relative position to the anchors associated with it.

In step 950 the data extraction process 520 calculates each of the scores given to each of the data fields by the extraction process and normalizes them.

The subject matter described herein can be implemented as one or more computer program products, i.e., one or more computer programs tangibly embodied in non-transitory media, e.g., in a machine-readable storage device, for execution by, or to control the operation of, data processing apparatus, e.g., a programmable processor, a computer, or multiple computers. A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Media suitable for embodying computer program instructions and data include all forms of volatile (e.g., random access memory) or non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

At least some of the subject matter described herein may be implemented in a computing system that includes a back-end component (e.g., a data server), a middleware component (e.g., an application server), or a front-end component (e.g., a client computer having a graphical user interface or a web browser through which a user can interact with an implementation of the subject matter described herein), or any combination of such back-end, middleware, and front-end components. The components of the system can be interconnected by any form or medium of digital data communication, e.g., a communication network. Examples of communication networks include a local area network (“LAN”) and a wide area network (“WAN”), e.g., the Internet.

The computing system may include clients and servers. A client and server are generally remote from each other in a logical sense and typically interact through a communication network. The relationship of client and server may arise by virtue of computer programs running on the respective computers and having a client-server relationship to each other.

A number of embodiments have been described. Nevertheless, it will be understood that various modifications may be made without departing from the spirit and scope of the invention. Accordingly, other embodiments are within the scope of the following claims.

1. A supply chain management system comprising:
a system server comprising a central processor and a database;
a plurality of user computers communicating with the system server over a network;
said system server running a software process defining:
an interface layer configured to communicate messages and business transactions bi-directionally between said user computers and said system server; and
a services layer configured to apply business logic to said messages and business transaction and process them according to a predefined workflow of said supply chain management system;
said plurality of user computers running client applications configured to communicate with said interface layer, said client applications comprising a virtual printer driver and virtual cloud printer application configured to virtually print documents into the system using said virtual print driver;
said service layer comprising a virtual cloud printer service configured to communicate bi-directionally with said virtual cloud printer application and with said database.

2. The system of claim 1, wherein said virtual printer driver is configured to receive a document and create therefrom a print file and an image file.

3. The system of claim 1, wherein said virtual cloud printer application comprises a virtual schema builder module configured to interactively build a schema definition for a new document format.

4. The system of claim 1, wherein said virtual cloud printer service comprises a data extraction module configured to identify a document type and wherein said virtual cloud printer application comprises a manual document input module configured to transfer virtually printed documents to the data extraction module.

5. The system of claim 4, wherein said identifying a document type comprises searching for keywords associated with different document definition schemas

6. The system of claim 1, wherein said virtual cloud printer application comprises a document point and extract module configured to interactively complete missing data in a virtually printed document.

7. A method of introducing a new schema of a document to a supply chain management system, comprising:
receiving a print file and an image file for each of a plurality of documents of a given document type;
locating anchor fields in the document according to said document type;
displaying said image file and marking said located anchor fields on said display;
receiving corrections to said displayed anchor fields; and
creating or updating a schema for the given document type; and
storing said schema.

8. The method of claim 7, wherein said receiving a print file and an image file of a document comprises virtually printing said document.

9. The method of claim 7, further comprising testing said created schema by receiving a print file and an image file for each of a number of test documents and analyzing said print file with said stored schema.

10. A method of manually inputting a document to a supply chain management system, comprising:
receiving a print file and an image file of said document;
extracting data from said print file;
identifying said document type, schema and content based on said extracted data;
if said document is identified as a transaction, converting said document into an internal system format and storing said converted document; and
if said document is not identified as a transaction, receiving a related transaction ID and connecting the document with said related transaction.

11. The method of claim 10, wherein said identifying document schema comprises:
rating schemas in a system repository according to best match of predefined key anchors; and
defining the document schema as the schema having the highest score.

12. The method of claim 11, wherein said rating a schema comprises:
for each anchor field defined in the schema, finding anchor field in the document and comparing anchor field location in the document to location defined in schema.

13. The method of claim 12, further comprising defining offsets for anchor fields in the document.

14. The method of claim 10, wherein said identifying document content comprises:
for each singular data field defined in the schema, rate data field according to location relative to related anchors.
